(19) United States
(12) Patent Application Publication
(10) Pub. No.: US 2005/0112522 A1
(43) Pub. Date: May 26, 2005

(54) Method for selecting color for a dental prosthesis

(76) Inventors: Mary F. Riley, Houston, TX (US); Colleen M. Foster, Houston, TX (US)

Correspondence Address: HOWREY SIMON ARNOLD & WHITE LLP, c/o IP DOCKETING DEPARTMENT, 2941 FAIRVIEW PARK DRIVE, SUITE 200, FALLS CHURCH, VA, 22042-7195, US

(21) Appl. No.: 10/723,213

(22) Filed: Nov. 26, 2003

(51) Int. Cl. A61C 19/10

(52) U.S. Cl. 433/26

(57) ABSTRACT

A method for selecting color for a dental prosthesis, preferably for achieving a desirable cosmetic effect. The method includes: determining a skin color from a first pantone of colors; determining a eye color from a second pantone of colors; selecting a shape of the dental prosthesis; and correlating the skin color, the eye color and the shape to a particular color for the dental prosthesis. In one embodiment, the first pantone of colors is based on a predetermined-selection of patient skin colors and a predetermined selection of patient skin complexions, and the second pantone of colors is based on a predetermined selection of patient eye colors. In one illustrative embodiment a percentage of a particular pantone color is utilized to achieve the desired cosmetic effect. Further the method may be carried out on a computer or over a computer network to provide a modified digital image of the patient to illustrate the cosmetic effect of a specific selection.

### BACKGROUND

Because of concerns about the visual appearance of their teeth, many people undergo clinical procedures to enhance their smile or to correct certain dental defects. Clinical or cosmetic procedures of this type generally involve the modification of tooth shape, alignment and color. An important step in the modification of a patient's tooth color is to determine the “shade” of an existing tooth. Such a determination is useful, for example, to patients seeking a whiter, brighter smile, for cosmetic purposes. In some instances it is desirable for the patient to be able to compare their existing tooth color so they can make a before and after treatment comparison and thus achieve the desired cosmetic effect. Shade determination is even more important when reconstructive work is done, since one goal of the process is to achieve a natural appearance.

At present, with respect to tooth color modification, most dentists utilize standardized shade guides created by companies which manufacture reconstructive materials. A variety of shade guides are available for visual comparison. For instance, one such shade guide is the VITA™ shade guide, which includes sixteen different shades. Other, shade guides used in practice include the guides provided by BIOFORMTM™ and SR-VIVADENT™.

For the most part, the existing shade guides are utilized in a rudimentary fashion. The guide itself is a plastic plate with a plurality of removable color tabs that are shaped like a tooth, e.g., the front tooth. Typically, to assess a patient's tooth shade, a dentist removes one or more of the colored tabs and holds them up to the patient's tooth to “eyeball” the closest match. Understandably, this approach sometimes fails, in part because of the need for a subjective assessment by the dentist. Another problem is that the color tab provides a limited view of the overall cosmetic effect of the change in tooth color. Thus the overall cosmetic effect of a particular tooth color is often difficult for the patient and the dentist to appreciate.

Another problem with the currently prevailing procedure is that once the tooth shade is determined, the information must be communicated correctly to the lab that makes the crown, bridge or denture. As known in the art, in bonding or filling a tooth, for example, the composite materials required for the restoration are specified within the range of the shade guide range. Errors in the determination of the tooth shade, or the communication of the determined shade to the lab will result in a poor shade match for the patient. For example, some dentists use uncommon shade guides, thereby leaving it to the lab technician to eyeball and convert the shade information to a specific standard shade. This too can result in improper shade matching.

The process for selecting the porcelain for a particular tooth shade illustrates the difficulty in assessing and manufacturing the correct color match. If, for example, a crown of VITA™ shade A3 is desired, porcelain is built by hand with a paint brush onto a model of the tooth to be restored. The porcelain is built in layers on the model to achieve translucency and natural appearance. Each layer has a particular color and intensity associated with it. To generate shade A3, the technician follows a “recipe” that is given by the manufacturer VITA™, requiring a different shade for each layer of porcelain applied. If a doctor asks for a shade that is not a VITA™ standard shade, the technician typically seeks to achieve that shade by combining different porcelain shade combinations together, to increase or decrease the chroma, hue and value of the shade.

In the prior art, several attempts have been made to use electronics and optical methods to measure tooth shade. Such prior art includes, without limitation, the following patents and publications, each of which is incorporated by reference as providing useful background information: JP 4-338465 by Kazeo Eto; JP 4301530 by Kisaka; U.S. Pat. No. 3,986,777; U.S. Pat. No. 4,247,202; U.S. Pat. No. 4,414,635; U.S. Pat. No. 4,518,258; U.S. Pat. No. 4,547,074; U.S. Pat. No. 4,623,973; U.S. Pat. No. 4,654,794; U.S. Pat. No. 4,692,481; U.S. Pat. No. 4,836,674; U.S. Pat. No. 4,881,811; U.S. Pat. No. 5,012,431; U.S. Pat. No. 5,124,797; U.S. Pat. No. 5,231,472; U.S. Pat. No. 5,240,414; U.S. Pat. No. 5,313,267; U.S. Pat. No. 5,343,267; U.S. Pat. No. 5,373,364; U.S. Pat. No. 5,383,020; U.S. Pat. No. 5,690,486; U.S. Pat. No. 5,759,030; WO 86/03292; WO 91/02955; U.S. Pat. No. 6,206,691.

Generally, the attempts to measure tooth shade, as disclosed in the illustrative prior listed above, fail for various reasons, including primarily color contamination due to reflection and/or tooth translucency. In addition to inconsistent and sometimes inadequate and unreliable tooth shade determination, methods and devices disclosed in the prior art also have other limitations. Electronic or optical measurements of one tooth's shade as disclosed in the prior art fail to adequately characterize the entire spatial extent of the tooth, much less address the issue of matching the shade of one tooth to the shades of adjacent teeth. Further, such methods can not take into account the overall final appearance of the cosmetic effect of a tooth brightening or whitening program.

As a result of the above, there remains and exists an unmet need for a method of selecting tooth shade that takes into account the overall cosmetic effect.

### SUMMARY

The subject matter of the present disclosure is generally directed a method for selecting color for a dental prosthesis. In one illustrative embodiment of the claimed subject matter, the method includes: determining a skin color from a first pantone of colors; determining a eye color from a second pantone of colors; selecting a shape of the dental prosthesis; and correlating the skin color, the eye color and the shape to a particular color for the dental prosthesis. It is preferred that the first pantone of colors is based on a predetermined selection of patient skin colors. It is also preferred that the second pantone of colors is based on a predetermined selection of patient eye colors. In one illustrative embodiment, a percentage value is assigned to each of the pantone colors. The shape selection of the prosthesis is based on the patient desired visual effect, tooth position and dental prognosis. The illustrative method may be carried out by the patient, the dentist, or the two in cooperation with each other. Further the method may be carried out on a computer or over a computer network. In such an illustrative embodiment, the computer can be used to provide a modified digital image of the patient to illustrate the cosmetic effect of a specific selection.

The claimed subject matter is also generally directed to a method of selecting teeth to obtain a desired cosmetic effect in a patient. In one illustrative embodiment of the claimed subject matter, the method includes: determining the patient's skin color based on a first pantone of predetermined skin colors; determining the patient's eye color based on a second pantone of predetermined eye colors; determining the shape of each tooth, and correlating the skin color, eye color and shape to a particular color for the teeth. The first pantone of colors is preferably based on a predetermined selection of patient skin colors and a predetermined selection of patient skin complexions. Similarly, the second pantone of colors is preferably based on a predetermined selection of patient eye colors. In one illustrative embodiment, a percentage value is assigned to the various pantone colors to achieve the desired cosmetic effect. Further the method may be carried out such that the shape selection of each tooth is based on the patient desired visual effect, tooth position and dental prognosis. The illustrative method may be carried out by the patient, the dentist, or the two in conjunction with each other. Further the method may be carried out on a computer or over a computer network. In such an illustrative embodiment, the computer can be used to provide a modified digital image of the patient to illustrate the cosmetic effect of a specific selection.

These and other features of the present invention are more fully set forth in the following description of preferred or illustrative embodiments of the invention.

### DESCRIPTION OF ILLUSTRATIVE EMBODIMENTS

The subject matter of the present disclosure is generally directed a method for selecting color for a dental prosthesis. As noted above, color of the teeth play an important role in the overall cosmetic effect and appearance of a person's smile. A color which does not closely match the existing conditions, or a color which is not suitable for patient can result in an aesthetic result that the patient is displeased with. Further in some instances the patient and dentist are unable to visualize the final resulting cosmetic effect of a specific color selection for the implant.

As disclosed herein, the method takes into account several factors that contribute to the overall appearance of a person and correlates those factors to a specific shade or color for the prosthesis. This in turn allows the patient and dentist to achieve the desired cosmetic effect that is aesthetically pleasing.

In one illustrative embodiment of the method of the claimed subject matter utilizes a first pantone of colors for determining skin color. The first pantone of colors is based on a predetermined selection of patient skin colors which are based on factors that affect flesh tones, such as race, ethnicity, sex, age, and so forth. In one illustrative embodiment, the first pantone of colors is created by images of a variety of individual people who are representative of each skin color class. That is to say the first pantone is based on a set of photographic or digital images of people and the patient's skin tone is compared and graded against this representative first pantone of skin tones. In another preferred and illustrative embodiment, at least three pantone colors are utilized which include, yellow, red, and brown, skin tones. One of skill in the art of cosmetics, personal color pallets and make-up application and technique should appreciate and be familiar with these three pantone colors for skin tones in the selection of clothing, make-up, etc . . . to give a certain aesthetic appearance. One aspect of the present method is that one may assign percentage values to each pantone color to formulate a unique skin color pallet for each patient. For example, a person of Northern European decent may have a skin color pallet that is 60% red, 30% yellow and 10% brown. However the assigning of specific percentages or ratios of pantone color is an optional aspect of the present invention. Optionally the skin color pantone may take into account the complexion of the skin by use of a color pallet that is based on at least three complexions types: light, medium and dark. Such a skin complexion pantone can be combined or used separately from the above described three color skin pantone (red, yellow, brown) system to provide a wide variety of possible skin tones within the over all first pantone of colors. As noted above, a wide variety of other factors (such as age, sex, ethnicity, etc . . . ) may be utilized to further refine the first pantone of skin color.

A second pantone of colors is utilized in the presently illustrative embodiment of the claimed subject matter for determining eye color. As with the first pantone, the second pantone of colors is based on a predetermined selection of patient eye colors which are based on factors that affect eye color, such as race, ethnicity, sex, age and so forth. In one illustrative embodiment, the second pantone of colors is created by images of a variety of individual people who are representative of each eye color class. That is to say the second pantone is based on a set of photographic or digital images of people and the patient's eye color is compared and graded against this representative pantone of eye colors. In another preferred and illustrative embodiment, at least three pantone colors are utilized which include, light, medium and dark, eye colors. One of skill in the art of cosmetics, personal color pallets and make-up application and technique should appreciate and be familiar with these three pantone colors for eye colors in the selection of clothing, make-up, etc . . . to give a certain aesthetic appearance. One aspect of the present method is that one may assign percentage values to each pantone color to formulate a unique color pallet for each patient. For example, a person of Northern European decent may have a eye color pallet that is 60% light, 30% medium and 10% dark based on the persons light blue eyes. However the assigning of specific percentages or ratios of pantone color is an optional aspect of the present invention.

The shape of the prosthesis is also a factor taken into consideration in the method of the claimed subject matter. Selection of the shape of the tooth may be based on the desired visual effect (such as overall shape, width and length), tooth position within the mouth of the patient and the patient's dental condition and prognosis. Prior art methods of selecting tooth color generally did not take into account the shape and position of the tooth within the patient's mouth. However, given the opacity and translucent nature of natural teeth, the patient and dentist must take these factors into account when deciding on a particular color shade for the prosthesis if the desired cosmetic effect is to be achieved.

Following the above noted steps, the patient and the dentist, can selected the standard shade for the prosthesis, given the above information on skin color, eye complexion and tooth shape, to give the desired cosmetic effect. That is to say the above information can be correlated to standard shade guides and formulations for the manufacture of the prosthesis tooth. Further this information can be included as part of the instructions to the technician who actually makes the prosthesis tooth to ensure that the desired cosmetic effect is achieved.

The illustrative method may be carried out by the patient, the dentist, a third party such as a spouse, parent or consultant in a collaborative manner with each other. This has considerable advantage because the dentist or technician is no longer the sole person making the decision as to the final color of the prosthetic tooth.

Further it should be appreciated by those of skill in the art that the method may be carried out on a computer or over a computer network. In such an illustrative embodiment, a digital image of the patient is captured and saved as a file on the computer. Then commercially available software, such as PHOTOSHOP™ or other similar image manipulation software, can be used to provide a modified digital image of the patient to illustrate the cosmetic effect of a specific selection. This process can be repeated as needed until the desired cosmetic effect is achieved. The computer then provides the dentist and the lab technician who actually makes the prosthesis tooth with above information so that the desired cosmetic effect is achieved.

In view of the above disclosure, one of ordinary skill in the art should understand and appreciate that one illustrative embodiment of the claimed subject matter includes a method for selecting color for a dental prosthesis. In one such an illustrative method the method includes: determining a skin color from a first pantone of colors; determining a eye color from a second pantone of colors; selecting a shape of the dental prosthesis; and correlating the skin color, the eye color and the shape to a particular color for the dental prosthesis. The first pantone of colors may be based on a predetermined selection of patient skin colors, preferably selected from red, yellow, and brown. Alternatively or in addition the first pantone of colors may include a predetermined skin complexion pantone and a predetermined skin color pantone. The second pantone of colors is based on a predetermined selection of patient eye colors, preferably selected from light, medium, and dark. In one preferred embodiment, a percentage value is assigned to each of the pantone colors. As noted above, the shape of the prosthesis has a significant impact on the overall cosmetic effect of the implant. Thus, the illustrative method takes into account the shape selection of the prosthesis which is based on the patient desired visual effect, tooth position and dental prognosis. The process of correlating the skin color, eye color and shape selection information may be carried out by the dentist or lab technician by use of a look-up table or it may be done using a computer.

Another illustrative embodiment of the claimed subject matter includes a method of selecting implanted teeth to obtain a desired cosmetic effect in a patient. The illustrative method includes: determining the patient's skin color based on a first pantone of predetermined skin colors; determining the patient's eye color based on a second pantone of predetermined eye colors; determining the shape of each tooth to be implanted, and correlating the skin color, eye color and shape to a particular color for the teeth. The illustrative method may be carried out using a first pantone of colors based on a predetermined selection of patient skin colors and a predetermined selection of patient skin complexions. Preferably this first pantone of colors is based on a predetermined selection of patient skin colors are selected from red, yellow and brown. Alternatively this first pantone of colors may be based on a set of images of people against who the patient's characteristics are measured. The illustrative method utilizes a second pantone of colors is based on a predetermined selection of patient eye colors. In one illustrative embodiment, the predetermined selection of patient eye colors are selected from light, medium, and dark. Alternatively this second pantone of colors may be based on a set of images of people against who the patient's characteristics are measured. A percentage value may assigned to each of the pantone colors for skin color and eye color so that each patient generates his/her own personalized color pallet based on the pantone of colors for skin and eye color. As noted above, the shape of the prosthesis has a significant impact on the overall cosmetic effect of the implant. Thus, the illustrative method takes into account the shape selection of the prosthesis, which is based on the patient desired visual effect, tooth position and dental prognosis. The process of correlating the skin color, eye color and shape selection information may be carried out by the dentist or lab technician by use of a look-up table or it may be done using a computer.

While the apparatus, compositions and methods disclosed above have been described in terms of preferred or illustrative embodiments, it will be apparent to those of skill in the art that variations may be applied to the process described herein without departing from the concept and scope of the claimed subject matter. All such similar substitutes and modifications apparent to those skilled in the art are deemed to be within the scope and concept of the subject matter as it is set out in the following claims.

1. A method for selecting color for a dental prosthesis, the method comprising:
determining a skin color from a first pantone of colors;
determining a eye color from a second pantone of colors;
selecting a shape of the dental prosthesis; and
correlating the skin color, the eye color and the shape to a particular color for the dental prosthesis.

2. The method of claim 1, wherein the first pantone of colors is based on a predetermined selection of patient skin colors.

3. The method of claim 1, wherein the second pantone of colors is based on a predetermined selection of patient eye colors.

4. The method of claim 1, wherein the first pantone of colors is selected from the group consisting of red, yellow, and brown.

5. The method of claim 1, wherein the first pantone of colors is selected from the group consisting of light, medium, and dark.

6. The method of claim 4, wherein a percentage value is assigned to each of the three pantone colors.

7. The method of claim 5, wherein a percentage value is assigned to each of the three pantone colors.

8. The method of claim 1, wherein the shape selection of the prosthesis is based on the patient desired visual effect, tooth position and dental prognosis.

9. The method of claim 1, wherein the first pantone of colors includes a predetermined skin complexion pantone and a predetermined skin color pantone.

10. A method of selecting teeth to obtain a desired cosmetic effect in a patient, the method comprising:
determining the patient's skin color based on a first pantone of predetermined skin colors;
determining the patient's eye color based on a second pantone of predetermined eye colors;
determining the shape of each tooth, and
correlating the skin color, eye color and shape to a particular color for the teeth.

11. The method of claim 10, wherein the first pantone of colors is based on a predetermined selection of patient skin colors and a predetermined selection of patient skin complexions.

12. The method of claim 10, wherein the second pantone of colors is based on a predetermined selection of patient eye colors.

13. The method of claim 11, wherein the predetermined selection of patient skin colors are selected from the group consisting of red, yellow and brown.

14. The method of claim 12, wherein the predetermined selection of patient eye colors are selected from the group consisting of light, medium, and dark.

15. The method of claim 13, wherein a percentage value is assigned to each of the three pantone colors.

16. The method of claim 14, wherein a percentage value is assigned to each of the three pantone colors.

17. The method of claim 10, wherein the shape selection of each tooth is based on the patient desired visual effect, tooth position and dental prognosis.

18. The method of claim 1, wherein the method is carried out with the assistance of a computer or computer network so as to provide a modified digital image to illustrate the cosmetic effect of a specific selection.

19. The method of claim 10, wherein the method is carried out with the assistance of a computer or computer network so as to provide a modified digital image to illustrate the cosmetic effect of a specific selection.
